(19) United States
(12) Patent Application Publication
(10) Pub. No.: US 2019/0196567 A1
(43) Pub. Date: Jun. 27, 2019

(54) ELECTRONIC DEVICE AND SLEEP CONTROL METHOD THEREOF

(71) Applicant: SHENZHEN ROYOLE TECHNOLOGIES CO. LTD., Shenzhen, Guangdong (CN)

(72) Inventor: Zegang YE, Shenzhen, Guangdong (CN)

(21) Appl. No.: 16/330,253

(22) PCT Filed: Dec. 8, 2016
(86) PCT No.: PCT/CN2016/109012

§ 371 Date: Mar. 4, 2019

(51) Int. Cl. G06F 1/3206; G06F 1/3234

(52) U.S. Cl. CPC G06F 1/3206; G06F 1/3234

(57) ABSTRACT

The present disclosure discloses a sleep control method, which is applied to an electronic device. The method comprises steps of: a temperature of the electronic device is detected; a time duration for entering sleep mode is adjusted according to the temperature of the electronic device detected currently; and the electronic device is controlled to enter a sleep mode when a non-operation time duration of the electronic device reaches the time duration for entering sleep mode. The present disclosure also discloses the electronic device. The electronic device and the sleep control method of the present disclosure, which can adjust the time duration for entering sleep mode according to current actual situations of the electronic device, so as to better meet requirements of the electronic device.

### RELATED APPLICATION

The present application is a National Phase of International Application Number PCT/CN2016/109012, filed Dec. 8, 2016.

### TECHNICAL FIELD

This present disclosure relates to an electronic device, and more particularly, to a sleepable electronic device and a sleep control method thereof.

### BACKGROUND

At present, electronic devices such as mobile phones, tablet computers, and head-mounted display devices have been used widely. In order to save power and improve endurance of the electronic device, the current electronic device has a function of entering a lock screen and sleep state after a non-operation time duration reaches a predetermined time duration. However, the time duration for entering sleep mode of the current electronic device is a default setting of a system or a fixed value set by the user. For the actual requirements of the electronic device, sometimes the optimal time duration for entering sleep mode may be longer than the fixed value, sometimes may shorter than the fixed value. Therefore, the fixed time duration for entering sleep mode often fails to meet the actual requirements of the electronic device.

### SUMMARY

Embodiments of the present disclosure provide an electronic device and a sleep control method thereof, which can adjust a time duration for entering sleep mode according to a temperature of the electronic device, and control the electronic device to enter a sleep mode according to the time duration for entering sleep mode, which is more in line with actual requirements that the electronic device enters the sleep mode.

Embodiments of the present disclosure provide an electronic device, which comprises a processor and a temperature sensor. The temperature sensor is configured to detect a temperature of the electronic device. The processor is coupled to the temperature sensor, and is configured to adjust a time duration for entering sleep mode according to the temperature of the electronic device currently detected by the temperature sensor, and control the electronic device to enter a sleep mode when a non-operation time duration of the electronic device reaches the time duration for entering sleep mode.

Embodiments of the present disclosure provide a sleep control method. The method comprises steps of: detecting a temperature of an electronic device; adjusting a time duration for entering sleep mode according to the temperature of the electronic device detected currently; and controlling the electronic device to enter a sleep mode when a non-operation time duration of the electronic device reaches the time duration for entering sleep mode.

The electronic device and the sleep control method thereof of the present disclosure can adjust the time duration for entering sleep mode, and control the electronic device to enter the sleep mode after a non-operation time duration reaches the time duration for entering sleep mode, and satisfy the actual requirements that the electronic device enters the sleep mode.

### BRIEF DESCRIPTION OF THE ACCOMPANYING DRAWINGS

To describe technology solutions in the embodiments of the present disclosure more clearly, the following briefly introduces the accompanying drawings required for describing the embodiments. Obviously, the accompanying drawings in the following description show merely some embodiments of the present disclosure, those of ordinary skill in the art may also derive other obvious variations based on these accompanying drawings without creative efforts.

FIG. 1 is a structural block diagram of an electronic device according to one embodiment of the present disclosure.

FIG. 2 is a schematic diagram of components included in a functional module of an electronic device according to one embodiment of the present disclosure.

FIG. 3 is a schematic diagram of a temperature curve according to one embodiment of the present disclosure.

FIG. 4 is a schematic diagram of a mapping table of temperature and time according to one embodiment of the present disclosure.

FIG. 5 is a schematic diagram showing changes in a display area of a display screen according to one embodiment of the present disclosure.

FIG. 6 is a flowchart of a sleep control method according to one embodiment of the present disclosure.

FIG. 7 is a sub-flowchart of step S605 in FIG. 6.

### DETAILED DESCRIPTION OF ILLUSTRATED EMBODIMENTS

The technical solution in the embodiments of the present disclosure will be described clearly and completely hereinafter with reference to the accompanying drawings in the embodiments of the present disclosure. Obviously, the described embodiments are merely some but not all the embodiments of the present disclosure. All other embodiments obtained by a person of ordinary skill in the art based on the embodiments of the present disclosure without creative efforts shall all fall within the protection scope of the present disclosure.

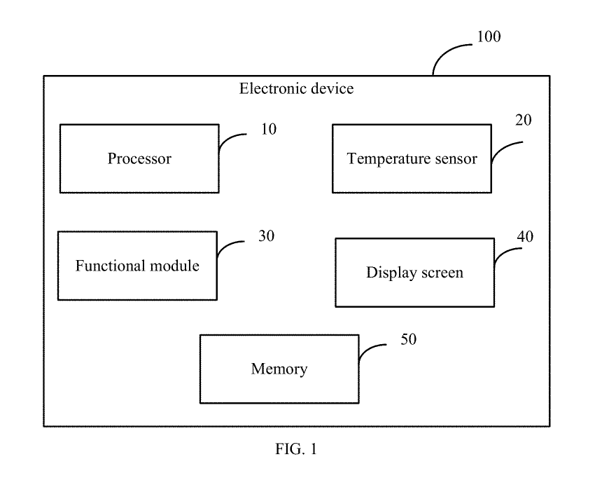

Referring to FIG. 1, a schematic diagram of an electronic device 100 according to one embodiment of the present disclosure is illustrated. As shown in FIG. 1, the electronic device 100 includes a processor 10 and a temperature sensor 20. The temperature sensor 20 is configured to detect a temperature T of the electronic device 100.

The processor 10 is coupled to the temperature sensor 20, configured to obtain the temperature detected by the temperature sensor 20, and adjust a time duration for entering sleep mode according to the temperature T of the electronic device 100 currently detected by the temperature sensor 20, and control the electronic device 100 to enter a sleep mode when a non-operation time duration of the electronic device 100 reaches the time duration for entering sleep mode. That is, timing begins when the temperature of the electronic device 100 reaches T and no operation is received, the processor 10 delays the “time duration for entering sleep mode” and controls the electronic device 100 to enter the sleep mode. Therefore, in some embodiments of the present disclosure, the electronic device 100 can adjust time duration for entering sleep mode according to the temperature of the electronic device 100, so that the electronic device 100 can enter the sleep mode when the non-operation time duration reaches the time duration for entering sleep mode, which is more in line with the actual requirements that electronic device 100 enters the sleep mode.

Where, the processor 10 controls the electronic device 100 to enter the sleep mode when the non-operation time duration reaches the time duration for entering sleep mode, including: the processor 10 starts timing after the operation applied on the electronic device 100 stops, and in the timing process, determines whether there is an operation applied on the electronic device. If not, the electronic device 100 is controlled to enter the sleep mode when the continuous timing is reached the time duration t for entering sleep mode. If the processor 10 determines that there is one operation applied on the electronic device 100 during the timing, the timing is then stopped, and the temperature detected by the temperature sensor 20 is re-acquired, and the foregoing functional steps are repeated. The non-operation of the electronic device 100 refers to no input operations or no operations of connecting, disconnecting, and the like of interface.

In some embodiments, the electronic device 100 further includes a functional module 30. The temperature of the electronic device 100 detected by the temperature sensor 20 is temperatures of the processor 10 and the functional module 30. The processor 10 obtains a system temperature T1 of the electronic device 100 according to the temperatures of the processor 10 and the functional module 30, and obtains a shell temperature T2 of the electronic device 100 according to the shell temperature T2 of the electronic device 100.

The processor 10 adjusts the current time duration for entering sleep mode to a time duration t for entering sleep mode corresponding to the current shell temperature T2 according to a correspondence between the shell temperature T2 and time duration t for entering sleep mode.

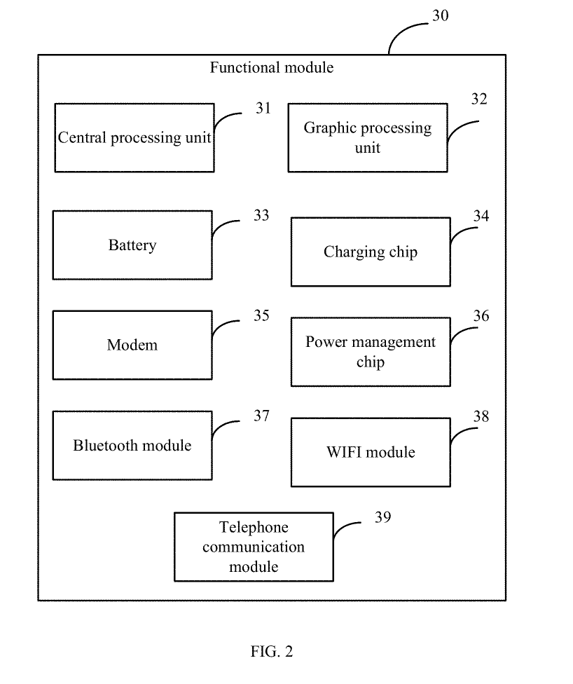

Referring further to FIG. 2, a functional block diagram of the functional module 30 is illustrated. As shown in FIG. 2, the functional module 30 includes, but is not limited to, a central processing unit (CPU) 31, a graphic processing unit (GPU) 32, a battery 33, a charging chip 34, a modem 35, and a power management chip 36, a Bluetooth module 37, a WIFI module 38, a telephone communication module 39 and the like. In some embodiments, there are multiple temperature sensors 20, and the multiple temperature sensors 20 are located at each of the components of the processor 10 and the functional module 30 for detecting the temperatures of the components of the processor 10 and the functional module 30, respectively. The telephone communication module 39 refers to a communication chip of a telephone network such as GPRS, CDMA, 3G, 4G, and the like.

In some embodiments, the processor 10 obtains the system temperature T1 of the electronic device 100 according to the temperatures of the processor 10 and the functional module 30, including: the temperatures of the processor 10 and the functional module 30 are acquired, and a maximum temperature in the obtained temperatures is determined as the system temperature T1. More specifically, the processor 10 obtains the temperatures of the central processing unit 31, the graphic processing unit 32, the battery 33, the charging chip 34, the modem 35, the power management chip 36, the Bluetooth module 37, the WIFI module 38, and the telephone communication module 39 in the processor 10 and the functional module 30, and determining the maximum temperature of the plurality of obtained temperatures as the system temperature T1.

In some embodiments, the processor 10 obtains the shell temperature of the electronic device 100 according to the system temperature, including: the shell temperature T2 of the electronic device 100 corresponding to the system temperature T1 is determined according to the correspondence between the system temperature T1 and the shell temperature T2.

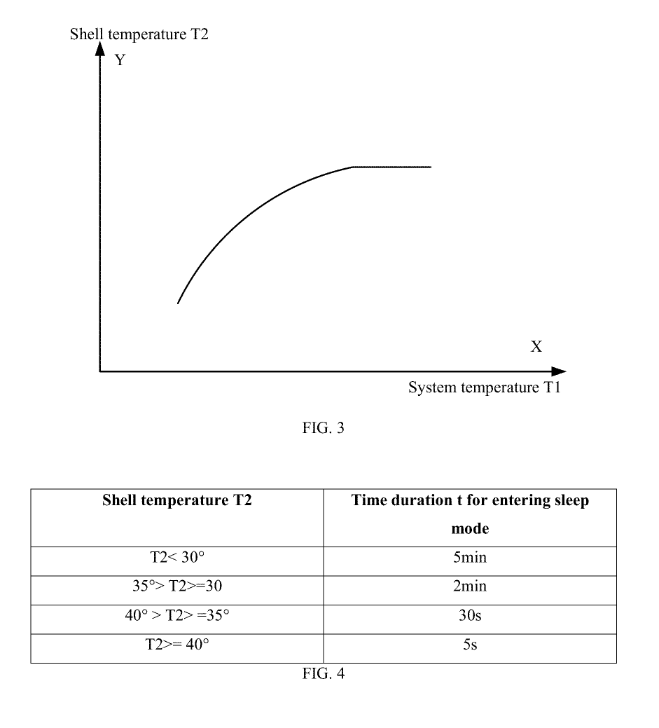

Referring further to FIG. 3, in some embodiments, the correspondence between the system temperature and the shell temperature is a temperature curve Q1. The system temperature T1 is an X-axis value, and the shell temperature T2 is a Y-axis value. After determining the system temperature T1, the processor 2 determines the shell temperature T2 corresponding to the system temperature T1 according to the temperature curve.

Where, the temperature curve Q1 may be obtained by testing the relationship between different system temperatures T1 and shell temperatures T2 in advance. As shown in FIG. 3, as the system temperature T1 increases, the shell temperature T2 also gradually increases. When the shell temperature T2 rises to a certain value, the shell temperature T2 will not rise with the system temperature T1 due to the influence of the external environment temperature.

In other embodiments, the correspondence between the system temperature T1 and the shell temperature T2 is a temperature mapping table, and the temperature mapping table records correspondence between the system temperature T1 and the shell temperature T2. Similarly, the temperature mapping table may be obtained by testing the relationship between different system temperatures T1 and shell temperatures T2 in advance.

Referring to FIG. 4, in some embodiments, the correspondence between the shell temperature T2 and the time duration t for entering sleep mode is a mapping table of temperature and time Tab1. The mapping table of temperature and time Tab1 records correspondences between different shell temperatures T2 and time duration t for entering sleep mode. The processor 10 determines the time duration t for entering sleep mode corresponding to the current shell temperature T2 according to the mapping table of temperature and time Tab1, and adjusts the current time duration t for entering sleep mode to a time duration t for entering sleep mode corresponding to the current shell temperature T2.

For example, as shown in FIG. 3, when the shell temperature T2 is less than 30 degrees Celsius, the corresponding time duration t for entering sleep mode is 5 min (minutes); when the shell temperature T2 is equal or greater than 30 degrees Celsius and less than 35 degrees Celsius, the corresponding time duration t for entering sleep mode is 2 minutes. When the shell temperature T2 is equal or greater than 35 degrees Celsius and less than 40, the corresponding time duration t for entering sleep mode is 30 seconds; when the shell temperature T2 is equal or greater than 40 degrees Celsius, it is a forced sleep mode, and the time duration t for entering sleep mode is 5 seconds or less.

Therefore, in some embodiments of the present disclosure, when the shell temperature T2 is higher, the time duration t for entering sleep mode is shorter, so the electronic device 100 can enter a cooling state more quickly, and the electronic device 100 can be more effectively protected.

Wherein, in the forced sleep mode, the processor 10 also controls to release the wake lock (wake_lock) of all applications in the electronic device 100, preventing the applications from blocking the electronic device 100 to sleep. In the forced sleep mode, the processor 10 controls the electronic device 100 to enter a deep sleep mode. Where, the electronic device 100 enters the deep sleep mode means that the central processing unit 31, the Bluetooth module 37, the WIFI module 38, the telephone communication module 39, and the background application of the electronic device 100 are all turned off.

In this embodiment, the processor 2 may be a micro controller, a micro-processor, a single chip microcomputer, a digital signal processor, or the like. In other embodiments, the processor 2 and the central processing unit 31 may be the same components.

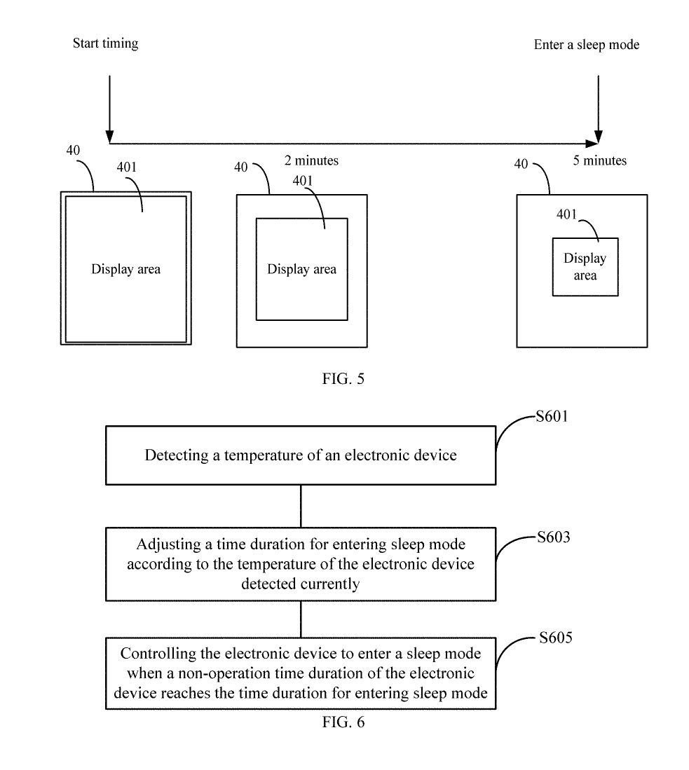

The electronic device 100 further includes a display screen 40. Referring further to FIG. 5, in some embodiments, the processor 2 is further configured to control the display area 401 of the display screen 40 to be adjusted during the non-operation time duration of the electronic device 100 before entering the sleep mode.

As shown in FIG. 5, the processor 2 controls the display area 401 of the display screen 40 to become smaller gradually during the non-operation time duration of the electronic device 100 before entering the sleep mode, and the non-display area 402 of the display screen 40 is a black screen. Therefore, the energy consumption is gradually reduced during the period of waiting for sleep, further saving the energy consumption of the electronic device 100 and helping the electronic device 100 to perform cooling.

For example, as shown in FIG. 5, when the current time duration t for entering sleep mode is 5 minutes, that is, the electronic device 100 enters the sleep mode after 5 minutes from now, the processor 2 controls the display area 401 to be an initial display size at the start of non-operation. When the non-operation time duration reaches 2 minutes, the display size of the display area 401 is controlled to be reduced to half of the initial display size, and when the non-operation time duration reaches 5 minutes, the display size of the display area 401 is controlled to be reduced to ¼ of the initial display size, and so on.

The processor 2 calls parameters of four sides (the left, the right, the upper and the lower side) of the application program interface (API) in the initial display size of the display area 401 in the system setting, and pixel positions of four vertices of the left, the right, the upper and the lower, and pixel positions of four sides of the display area 401 in the initial display size. The processor 2 also changes the pixel positions of the four vertices of the left, the right, the upper and the lower, and four sides of the display area 401 under the initial display size, thereby adjusting the display size of the display area 401.

In some embodiments, the processor 2 adjusts display parameters of content displayed by the display screen 40 according to the shell temperature T2 when the electronic device 100 is in a period from non-operation to entering sleep mode.

Where, the display parameters include a color temperature and/or a hue. The processor 2 controls the color temperature and/or the hue of the content displayed by the display screen 40 to be a warmer color temperature and/or hue when the shell temperature is higher, such as, it is adjusted to be red color temperature/hue. The processor 2 controls the color temperature and/or the hue of the content displayed by the display screen 40 to be a cooler color temperature and/or hue when the shell temperature T2 is cooler, such as it is adjusted to be white color temperature and/or hue.

Where, the processor 2 controls color offset of pixel value of each pixel of the display content by setting the hue adjustment function of the electronic device 100, and calling the set hue adjustment function, and controls the display screen 40 to display according to the pixel value with color offset of each pixel. Therefore, the overall color temperature/hue of the displayed content is adjusted.

The processor 10 is further configured to determine whether the electronic device 100 enters a forced sleep mode according to the temperature of the electronic device 100. For example, when the shell temperature T2 of the aforementioned electronic device 100 is greater than or equal to 40 degrees Celsius, the processor 10 controls the electronic device 100 to enter the forced sleep mode, and when the shell temperature T2 is less than 40 degrees Celsius, the processor 10 controls the electronic device 100 to enter a non-forced sleep mode. Where in the forced sleep mode, the processor 10 controls the electronic device 100 to enter a deep sleep mode.

In some embodiments, in the non-forced sleep mode, for example, when the shell temperature T2 is less than 40 degrees Celsius as described above, the processor 10 controls the electronic device 100 to enter the sleep mode, including: the processor 10 controls input and output devices such as the display screen 40, a touch panel (not shown), an external sensor (not shown, such as a proximity sensor, a light sensor, etc.), or the like to be closed firstly, and then determines whether the electronic device 100 has unfinished tasks that are currently running; and if yes, controls the electronic device 100 to enter a shallow sleep mode, that is, the central processing unit 31 still works; and if not, controls the electronic device 100 to enter the deep sleep mode, at this time, the central processing unit 31 stops working.

As described above, the processor 10 controls the electronic device 100 to enter the deep sleep mode, includes: the wake locks of all tasks are released, the electronic device 100 is forced to enter the deep sleep mode, the processing unit 31 is forcibly stopped regardless of whether or not unfinished tasks are in progress in the electronic device 100.

Referring to FIG. 1, the electronic device 100 further includes a memory 50 for storing the aforementioned temperature curve Q1 and mapping table of temperature and time Tab1. The memory 50 can be a flash memory card, a solid state memory, or the like.

Where, the display screen 40 can be a touch display screen.

The electronic device 100 can be a mobile phone, a tablet computer, a notebook computer, a desktop computer, a head mounted display device, or the like.

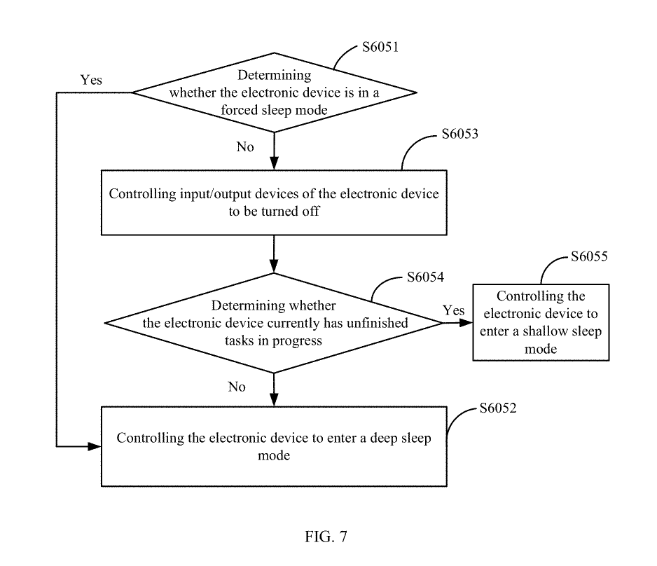

Referring to FIG. 6, a flowchart of a sleep control method according to one embodiment of the present disclosure is illustrated. The method is applied to the aforementioned electronic device 100. The method includes the steps of:

The temperature sensor 20 detects a temperature of the electronic device 100 (S601). Specifically, the current temperature of the electronic device 100 detected by the temperature sensor 20 is the temperatures of the processor 10 and the functional module 30 of the electronic device 100.

The processor 10 adjusts a time duration t for entering sleep mode according to the temperature T of the electronic device 100 currently detected by the temperature sensor 20 (S603). Specifically, the processor 10 obtains the system temperature T1 of the electronic device 100 according to the temperatures of the processor 10 and the functional module 30, and obtains the shell temperature T2 of the electronic device 100 according to the system temperature T1, and then adjusts the time duration t for entering sleep mode according to the shell temperature T2 of the electronic device 100.

When a non-operation time duration of the electronic device 100 reaches the time duration t for entering sleep mode, the processor 10 controls the electronic device 100 to enter a sleep mode (S605).

The controller 10 obtains the shell temperature T2 of the electronic device 100 according to the system temperature T1, includes: the shell temperature T2 of the electronic device 100 corresponding to the system temperature T1 is determined according to the correspondence between the system temperature T1 and the shell temperature T2. In some embodiments, the correspondence between the system temperature and the shell temperature is a temperature curve Q1, the system temperature T1 is an X axis, and the shell temperature T2 is a Y axis. After determining the system temperature T1, the processor 2 determines the shell temperature T2 corresponding to the system temperature T1 according to the temperature curve Q1.

In some embodiments, the “adjusting the time duration t for entering sleep mode according to the shell temperature T2 of the electronic device 100” includes: the processor 10 adjusting the current time duration for entering sleep mode to a time duration t for entering sleep mode corresponding to shell temperature T2 according to the correspondence between the shell temperature T2 and the time duration t for entering sleep mode. In some embodiments, the correspondence between the shell temperature T2 and the time duration t for entering sleep mode is a mapping table of temperature and time Tab1, and the mapping table of temperature and time Tab1 records correspondence between different shell temperatures T2 and time duration t for entering sleep mode.

In some embodiments, the method further includes a step between the step S603 and the step S605: the processor 10 controls a size of the display area 401 of the display screen 40 to be adjusted during the non-operation time duration of the electronic device 100 before entering the sleep mode. For example, the processor 10 controls the display area 401 of the display screen 40 to become smaller gradually during the non-operation time duration of the electronic device 100 before entering the sleep mode.

The processor 10 calls parameters of four sides (the left, the right, the upper and the lower sides) of the application program interface (API) in the initial display size of the display area 401 in the system setting, and pixel positions of four vertices of the left, the right, the upper and the lower, and pixel positions of four sides of the display area 401 in the initial display size. The processor 2 also changes the pixel positions of the four vertices of the left, the right, the upper and the lower, and four sides of the display area 401 under the initial display size, thereby adjusting the display size of the display area 401.

In some embodiments, the method further includes a step between the step S603 and the step S605: the processor 10 further adjusts display parameters of the content displayed by the display screen 40 according to the shell temperature T2. Where, the display parameter includes a color temperature and/or a hue, and the processor 10 controls the color temperature and/or hue of the content displayed by the display screen 40 to be the warmer color temperature and/or hue when the shell temperature T2 is higher. The processor 2 controls the color temperature and/or the hue of the content displayed by the display screen 40 to be cooler color temperature and/or hue when the shell temperature T2 is lower, such as it is adjusted to be white color temperature and/or hue.

Where, the processor 2 controls color offset of pixel value of each pixel of the display content by setting the hue adjustment function of the electronic device 100, and calling the set hue adjustment function, and controls the display screen 40 to display according to the pixel value with color offset of each pixel. Therefore, the overall color temperature/hue of the displayed content is adjusted.

Referring to FIG. 7, a sub-flowchart of step S605 is illustrated. Where, the processor 10 controls the electronic device 100 to enter the sleep mode specifically includes:

The processor 10 determines whether the electronic device 100 is in a forced sleep mode (S6051). If yes, step S6052 is performed, and if no, step S6053 is performed. Where, the processor 10 determines it is the forced sleep mode when the temperature of the shell temperature T2 is greater than or equal to a predetermined value, and determines it is a non-forced sleep mode when the predetermined value is smaller than the predetermined value.

The processor 10 controls the electronic device 100 to enter a deep sleep mode (S6052). Where, the electronic device 100 is controlled to enter the deep sleep mode refers to: the wake locks of all tasks are released, the system is forced to enter the deep sleep mode, the central processing unit 31 is forcibly stopped regardless of whether or not unfinished tasks are in progress in the electronic device 100.

The input/output devices such as display screen 40, a touch panel (not shown), and an external sensor (not shown) and the like of the electronic device 100 are turned off (S6053).

It is determined whether the electronic device 100 currently has unfinished tasks in progress (S6054). If yes, the process goes to step S6055, if no, the process goes to step S6052.

The electronic device 100 is controlled to enter a shallow sleep mode (S6055). Where, in the shallow sleep mode, the central processing unit 31 still works.

Therefore, the electronic device 100 and the sleep control method of the present disclosure can adjust the time duration for entering sleep mode according to the temperature of the electronic device 100. When the temperature of the electronic device 100 is higher, the time duration for entering sleep mode is shorter, so that the electronic device 100 can be cooled down as quickly as possible when the temperature is too higher.

The above is a preferred embodiment of the present disclosure, and it should be noted that those skilled in the art may make some improvements and modifications without departing from the principle of the present disclosure, and these improvements and modifications are also the protection scope of the present disclosure.

1. An electronic device, comprising a processor, wherein, the electronic device further comprises a temperature sensor for detecting a temperature of the electronic device, and the processor is coupled to the temperature sensor, configured for adjusting a time duration for entering sleep mode according to the temperature of the electronic device currently detected by the temperature sensor, and controlling the electronic device to enter a sleep mode when a non-operation time duration of the electronic device reaches the time duration for entering sleep mode.

2. The electronic device according to claim 1, wherein, the processor starts timing after operations applied on the electronic device are stopped, and determines whether there is an operation applied on the electronic device during the timing, and if not, continues to timing until the time duration for entering sleep mode is reached, the electronic device is controlled to enter the sleep mode.

3. The electronic device according to claim 1, wherein, the electronic device further comprises a functional module; and the temperature of the electronic device detected by the temperature sensor is temperatures of the processor and the functional module of the electronic device; the processor obtains a system temperature of the electronic device according to the temperatures of the function module and the processor, and obtains a shell temperature of the electronic device according to the system temperature, and adjust the time duration for entering sleep mode to a time duration for entering sleep mode corresponding to the shell temperature according to a correspondence between the shell temperature and the time duration for entering sleep mode.

4. The electronic device according to claim 3, wherein, the processor obtains the temperatures of the functional module and the processor, and determines a maximum temperature of the obtained temperature as the system temperature.

5. The electronic device according to claim 3, wherein, the processor determines the shell temperature of the electronic device corresponding to the system temperature according to the correspondence between the system temperature and the shell temperature.

6. The electronic device according to claim 5, wherein, the correspondence between the system temperature and the shell temperature is a temperature curve; the system temperature is an X-axis value, and the shell temperature is a Y-axis value; after determining the system temperature, the processor determines the shell temperature corresponding to the system temperature according to the temperature curve.

7. The electronic device according to claim 3, wherein, the correspondence between the shell temperature and the time duration for entering sleep mode is a mapping table of temperature and time; and the mapping table of temperature and time records different correspondence between the shell temperature and the time duration for entering sleep mode; the processor determines the time duration for entering sleep mode according to the mapping table of temperature and time, and adjusts the current time duration for entering sleep mode to the time duration for entering sleep mode corresponding to the current shell temperature.

8. The electronic device according to claim 7, wherein, when the shell temperature T2 is less than 30 degrees Celsius, the corresponding time duration for entering sleep mode is 5 minutes; when the shell temperature T2 is equal or greater than 30 degrees Celsius and less than 35 degrees Celsius, the corresponding time duration for entering sleep mode is 2 minutes; when the shell temperature T2 is equal or greater than 35 degrees Celsius and less than 40 degrees Celsius, the corresponding time duration for entering sleep mode is 30 seconds; when the shell temperature T2 is equal or greater than 40 degrees Celsius, the time duration for entering sleep mode is less than or equal to 5 seconds.

9. The electronic device according to claim 1, wherein the electronic device further comprises a display screen; and the processor is further configured to control a display area of the display screen gradually becomes smaller during the non-operation time duration of the electronic device before entering the sleep mode.

10. The electronic device according to claim 3, wherein, the processor is further configured to adjust display parameters of content displayed by the display screen according to the shell temperature during the non-operation time duration of the electronic device before entering the sleep mode.

11. The electronic device according to claim 10, wherein the display parameters comprise a color temperature and/or a hue; and the processor controls the color temperature and/or the hue of the content displayed by the display screen to be warmer color temperature and/or hue when the shell temperature is higher; and the processor controls the color temperature and/or the hue of the content displayed by the display screen to be cooler color temperature and/or hue when the shell temperature is lower.

12. The electronic device according to claim 1, wherein the processor is further configured to determine whether the electronic device enters a forced sleep mode according to the temperature of the electronic device; if yes, the processor controls the electronic device to enter a deep sleep mode; if not, the processor controls to turn off input and output devices of the electronic device, and then determines whether the electronic device has unfinished tasks that are currently running; and controls the electronic device to enter a shallow sleep mode when there are unfinished tasks; and controls the electronic device to enter the deep sleep mode when there are no unfinished tasks.

13. A sleep control method, applied to an electronic device, the method comprising steps of:
detecting a temperature of the electronic device;
adjusting a time duration for entering sleep mode according to the temperature of the electronic device detected currently;
controlling the electronic device to enter a sleep mode when a non-operation time duration of the electronic device reaches the time duration for entering sleep mode.

14. The sleep control method according to claim 13, wherein, the step “controlling the electronic device to enter a sleep mode when a non-operation time duration of the electronic device reaches the time duration for entering sleep mode”, comprises:
starting timing after operations applied on the electronic device is stopped, and during the timing, determining whether there is an operation applied on the electronic device, if not, controlling the electronic device to enter the sleep mode when the time duration for entering sleep mode is reached.

15. The sleep control method according to claim 13, wherein the electronic device further comprises a functional module, the step “detecting a temperature of the electronic device”, comprises:
detecting temperatures of the processor and the functional module;
the step “adjusting a time duration for entering sleep mode according to the temperature of the electronic device detected currently”, comprises:
obtaining a system temperature of the electronic device according to the temperatures of the processor and the functional module;
obtaining a shell temperature of the electronic device according to the system temperature;
adjusting the current time duration for entering sleep mode to be a time duration for entering sleep mode corresponding to the current shell temperature according to the correspondence between the shell temperature and the time duration for entering sleep mode.

16. The sleep control method according to claim 15, wherein, the step “obtaining a system temperature of the electronic device according to the temperatures of the processor and the functional module”, comprises:
obtaining the temperatures of the processor and the functional module, and determining a maximum temperature in the obtained temperature as the system temperature.

17. The sleep control method according to claim 15, wherein, the step “obtaining a system temperature of the electronic device according to the temperatures of the processor and the functional module”, comprises:
the processor determining the shell temperature of the electronic device corresponding to the system temperature according to a correspondence between the system temperature and the shell temperature, where the correspondence between the system temperature and the shell temperature is a temperature curve.

18. The sleep control method according to claim 13, wherein, the method further comprises:
controlling a display area of the display screen to becomes smaller gradually during the non-operation time duration of the electronic device before entering the sleep mode.

19. The sleep control method according to claim 15, wherein, the method further comprises:
adjusting display parameters of content displayed by the display screen according to the shell temperature during the non-operation time duration of the electronic device before entering the sleep mode.

20. The sleep control method according to claim 13, wherein, the step “controlling the electronic device to enter a sleep mode when a non-operation time duration of the electronic device reaches the time duration for entering sleep mode”, comprises:
determining whether the electronic device enters a forced sleep mode according to the temperature of the electronic device;
if yes, the processor controlling the electronic device to enter a deep sleep mode;
if not, the processor controlling to turn off input and output devices of the electronic device;
then, determining whether the electronic device has unfinished tasks that are currently running;
controlling the electronic device to enter a shallow sleep mode when there are unfinished tasks; and
controlling the electronic device to enter the deep sleep mode when there are no unfinished tasks.
